(19) United States
(12) Patent Application Publication
(10) Pub. No.: US 2005/0274211 A1
(43) Pub. Date: Dec. 15, 2005

(54) Motor vehicle power seat drive shaft housing assembly

(75) Inventor: Thomas J. Edgman, Farmers Branch, TX (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: VINYLEX CORPORATION, KNOXVILLE, TN (US)

(21) Appl. No.: 10/853,588

(22) Filed: May 25, 2004

(51) Int. Cl. F16H 21/12

(52) U.S. Cl. 74/63

(57) ABSTRACT

An automotive power seat drive shaft housing assembly includes an outer housing member having a central bore for receiving a press fitted connector member, the opposite ends of the connector member extending beyond the opposite ends of the outer housing member. The connector member is adapted to be fitted into hubs of a drive motor and gear housing, respectively. A flexible tubular bearing member is disposed in a bore of the elongated connector member and journals a drive shaft. The outer housing has surface interruptions in the way of splines or projections or a non-circular or polygonal cross section to indicate that the drive shaft housing assembly is not a manual actuating lever for a manual seat adjustment mechanism. The housing members and bearing member are preferably formed of extruded PVC.

### BACKGROUND OF THE INVENTION

Power seat mechanisms for automotive vehicles have become relatively highly developed. Conventional automobile power seats include a mechanism for moving the seat rearwardly and forwardly with respect to the driver's control panel or dashboard by an electric motor driving a rotatable shaft which is drivably connected to a mechanism for moving the seat frame with respect to elongated seat support rails. Typically, the motor and drive shaft support structure or housing are mounted transversely under the front edge of the seat cushion. This location is also the general location of an actuating lever for motor vehicle seats which have manually actuated seat position adjustment mechanisms. Accordingly, a person sitting in a power seat and not realizing that the seat is power operated, might grasp the aforementioned drive shaft housing of the power seat and, assuming it is a manual seat actuating lever, exert tremendous force which could result in damage or total failure of the drive shaft housing assembly.

Other problems associated with prior art vehicle power seat mechanisms include noise generated by the drive shaft during operation thereof and the requirement for lubrication of the drive shaft and/or the bearing structure of the drive shaft housing which supports the drive shaft.

The present invention overcomes the aforementioned problems in vehicle power seat mechanisms, particularly with respect to a housing assembly for the drive shaft of a motor which is operable to move the seat between working positions.

### SUMMARY OF THE INVENTION

The present invention provides an improved drive shaft housing assembly for a power seat positioning mechanism for a motor vehicle power seat.

In accordance with one aspect of the present invention, a power seat drive shaft housing assembly is provided which may include an outer housing member, a connector member which is disposed in fixed relation to the outer housing member and is characterized by opposed splined ends for non-rotatably connecting the housing assembly to a motor housing and to a drive mechanism housing, respectively, and a tubular bearing member disposed within a bore of the connector member and adapted to journal an elongated drive shaft. The outer housing member is preferably provided with a cross-sectional geometry or surface interruptions which may be felt by a person grasping the outer housing member to alert the person that the drive shaft housing assembly is not a manual actuating lever for a manual seat adjustment mechanism.

In accordance with another important aspect of the present invention, a drive shaft housing assembly for a vehicle power seat mechanism is provided which includes a novel shaft bearing configuration whereby an elongated tubular sleeve bearing or liner is dimensioned to be closely fitted in the bore of an intermediate or outer housing member, but freely rotatable therein, the tubular bearing member also serving as a bearing for supporting a rotatable drive shaft. The outer housing or cover member of the housing assembly is preferably formed of rigid polyvinyl chloride (PVC), the intermediate or connector member is also provided of rigid PVC, and the tubular bearing or liner member is preferably provided of flexible PVC.

The drive shaft housing assembly of the present invention provides several advantages. The housing assembly may be easily and economically fabricated of three parts which may be separately extruded and then assembled prior to connection of the housing assembly to a drive motor and to further power seat drive mechanism. The outer housing or cover is provided with a shape or with surface interruptions to alert a person grasping the housing assembly that it is not a handle or handhold or an actuating lever of a seat mechanism. The novel combination of housing member and tubular liner or bearing member eliminates the requirement for placing a lubricant in the bearing bore of the housing assembly for lubricating a drive shaft.

Those skilled in the art will further appreciate the above-mentioned advantages and superior features of the invention together with other important aspects thereof upon reading the detailed description which follows in conjunction with the drawings.

### BRIEF DESCRIPTION OF THE DRAWINGS

FIG. 1 is a perspective view of a conventional motor vehicle power seat frame and actuating mechanism and including the improved drive shaft housing assembly of the present invention;

FIG. 2 is a longitudinal side elevation of the drive shaft housing assembly shown in FIG. 1;

FIG. 3 is a section view taken generally along the line 3-3 of FIG. 2;

FIG. 4 is a section view taken generally along the line 4-4 of FIG. 2;

FIG. 5 is a section view similar to FIG. 4 showing a first alternate embodiment of a housing assembly in accordance with the invention;

FIG. 6 is a section view similar to FIG. 4 showing a second alternate embodiment of a housing assembly in accordance with the invention;

FIG. 7 is a section view similar to FIG. 4 showing a third alternate embodiment of a housing assembly in accordance with the invention; and

FIG. 8 is a section view similar to FIG. 4 showing a fourth alternate embodiment of a housing assembly in accordance with the invention.

### DETAILED DESCRIPTION OF THE PREFERRED EMBODIMENTS

In the description which follows, like parts are marked throughout the specification and drawing with the same reference numerals, respectively. The drawing figures are not necessarily to scale and certain features may be shown exaggerated in scale or in somewhat generalized or schematic form in the interest of clarity and conciseness.

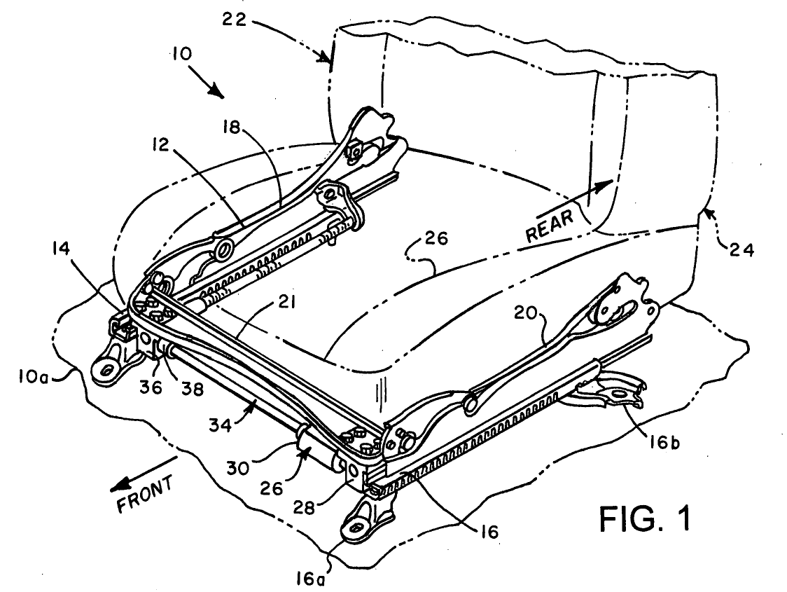

Referring to FIG. 1, there is illustrated a seat assembly for a conventional automotive motor vehicle and generally designated by the numeral 10. The seat assembly 10 includes a seat frame 12 including opposed spaced apart generally parallel support rails 14 and 16 which are provided with suitable feet, two shown for rail 16 and designated by numerals 16a and 16b, whereby the rails may be bolted to the floor 10a of a vehicle cabin. Seat rails 14 and 16 support spaced apart seat frame members 18 and 20, respectively, for longitudinal movement of the seat frame 12 toward the front of the vehicle and toward the rear of the vehicle, as indicated by the legends and arrows in FIG. 1.

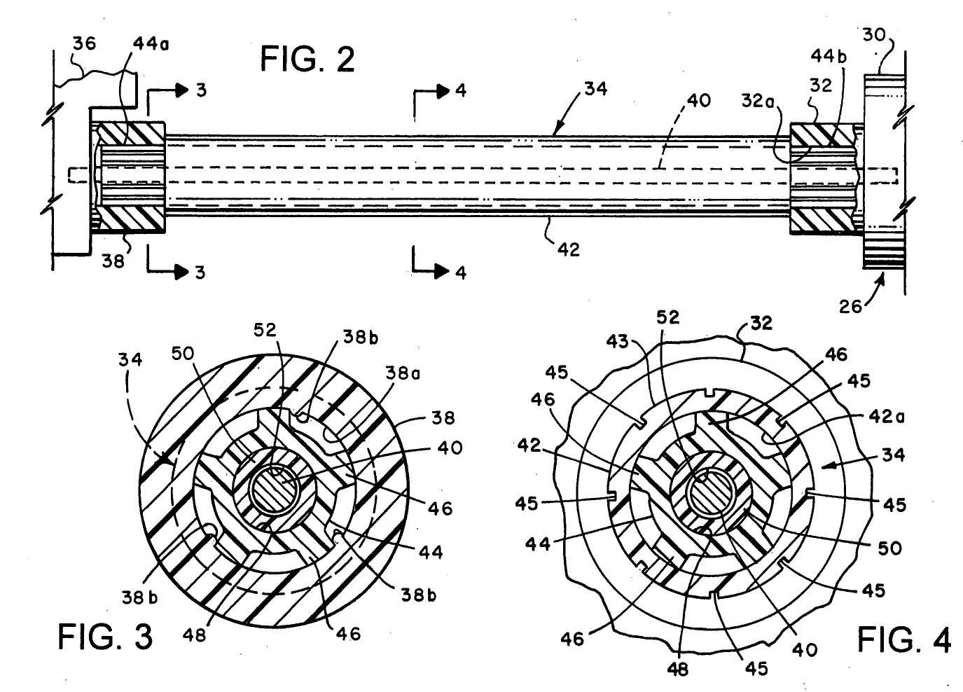

Seat frame 12 is adapted to support a seat 22 including a backrest 24 and a cushion 26. Seat frame members 18 and 20 are interconnected by a transverse member 21 and a drive mechanism, including an electric motor 26, is mounted beneath frame member 21 and connected to a first gear housing 28. Motor 26 includes a motor housing 30 having a hub 32, see FIG. 2, for supporting one end of an elongated drive shaft housing assembly, generally designated by the numeral 34. The opposite end of drive shaft housing assembly 34 is connected to a second gear housing 36 having a hub 38 disposed opposite and coaxial with the motor housing hub 32, see FIG. 2 also. Gear housings 28 and 36 are adapted to support suitable drive mechanism, not shown, for effecting movement of the seat frame members 18 and 20 along the rails 14 and 16 in a manner generally known to those skilled in the art of power seat mechanisms. Motive power for operating the aforementioned mechanism is provided by the motor 26 which is adapted to drive a rotatable drive shaft 40, see FIG. 2, supported within the housing assembly 34 to provide power to mechanism disposed in gear housing 36. The opposite end of the motor 26 includes an output shaft, not shown, but operably connected to the gear housing 28 to provide power to mechanism disposed therein.

Referring now to FIGS. 2, 3 and 4, the drive shaft housing assembly 34 is advantageously provided with an outer, generally cylindrical, tubular housing member or cover 42 which non-rotatably journals an elongated splined connector member 44 having opposite distal ends 44a and 44b, FIG. 2, which project beyond the opposite ends of the outer housing or cover 42, respectively. Outer housing or cover 42 includes a cylindrical bore 42a, FIG. 4, which receives the connector member 44 in sleeved relationship therein. Connector member 44 is provided with plural circumferentially spaced radially projecting elongated splines 46, the radially outermost surfaces of which are dimensioned such that connector member 44 is a press fit in the bore 42a so that the connector member 44 is non-rotatable with respect to the member 42. Connector end part 44a is a snug fit within a bore 38a of hub 38 and is non-rotatable therein at least in part due to the provision of longitudinal bosses 38b, FIG. 3, which project radially inwardly and are engageable with the splines 46 to prevent rotation of the housing assembly 34 with respect to the gear housing 36. In like manner, the boss 32 of motor housing 30 is preferably provided with a generally cylindrical bore 32a, FIG. 2, which may also be provided with spaced apart longitudinal bosses or projections similar to the bosses or projections 38b to assist in preventing rotation of housing 34 with respect to the motor housing 30.

As shown in FIGS. 3 and 4, elongated connector member 38 includes a central cylindrical bore 48 formed therein for receiving an elongated tubular liner or bearing member 50. Bearing member 50 includes a central cylindrical bore 52 for receiving drive shaft 40 in supportive relationship whereby drive shaft 40 may be rotated with respect to bearing member 50, although bearing member 50 may also rotate freely relative to connector member 44. Drive shaft 40 may be of the spiral wound flexible wire type or a solid rod and having opposed polygonal cross-section drive tangs formed on opposite ends engageable with suitable drive mechanism within housing 36 on one end and with a suitable rotatable shaft, not shown, of motor 26 at its opposite end.

The housing assembly 34 may be advantageously formed of extruded plastic parts including the outer housing or cover 42, the connector member 44, and the tubular bearing member 50, respectively. For example, the outer housing 42 and the connector member 44 may be separately formed of extruded rigid polyvinyl chloride (PVC) plastic and the tubular bearing member 50 may be formed of flexible PVC having a durometer of about 70 to 100 Shore A, preferably about 92 Shore A. Housing member 42 and connector member 44 may also be integrally formed. However, extrusion of members 42 and 44 separately is advantageous in the interest of material savings and ease of manufacture. The members 42 and 44 may then be assembled to each other by press fitting the member 44 within the bore 42a as previously described. Thanks to providing the tubular bearing member 50 of flexible PVC, this member has inherent self-lubrication properties and drive shaft 40 does not require the addition of a separate lubricant within the bore 52 of bearing 50 nor does bearing 50 require the use of a lubricant between its outer surface and the bearing bore 48 of connector 44.

Referring further to FIG. 4, outer housing member 42 is advantageously provided with surface interruptions on its outer circumferential surface 43 in the form of longitudinal grooves 45 which are circumferentially spaced apart as shown. Grooves 45 may be relatively shallow and are provided primarily for the purpose of providing a certain tactile feel to the structure of the housing assembly 34 if it is inadvertently grasped by a person seated in the seat 10 and wherein such person assumes that the seat 10 has a manual adjustment mechanism and that the shaft housing assembly 34 is part of a conventional actuating lever for a manually adjustable seat. Typically, manual seat adjustment mechanisms for automotive vehicles comprise a smooth walled tubular member extending across and under the front of the seat cushion. However, a person mistakenly grasping the housing assembly 34 with the thought that it is a manual actuating lever for a manual seat adjustment mechanism would immediately have some doubt that this was the case upon feeling the surface interruptions provided by the grooves 45, thus avoiding, in almost any instance, the prospect that the drive shaft housing assembly 34 might be forcibly damaged.

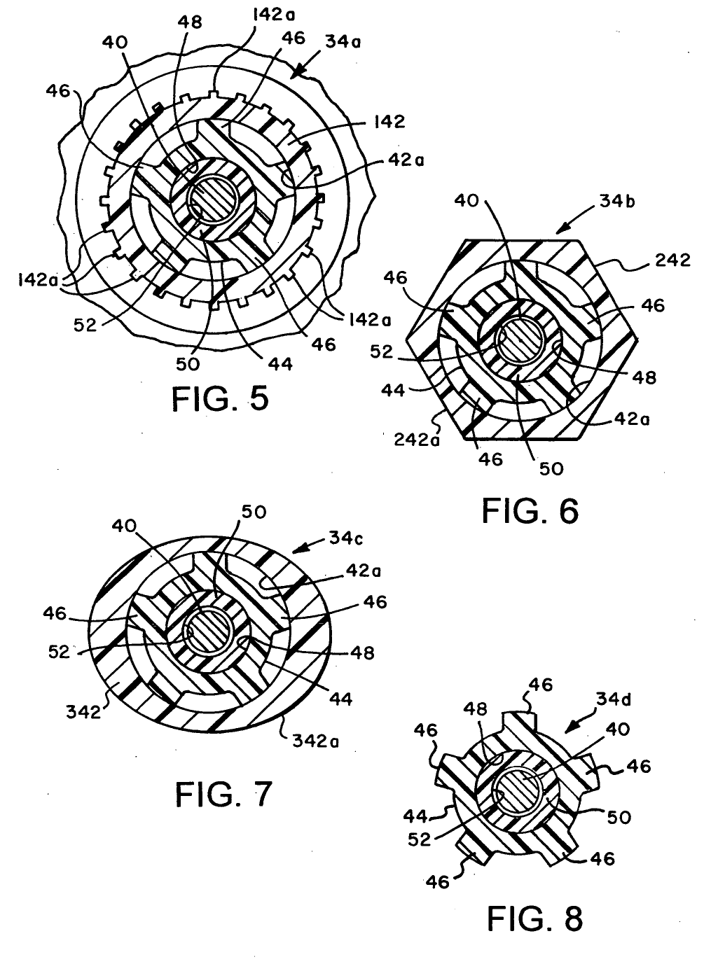

Referring to FIG. 5, there is illustrated an alternate embodiment of the present invention comprising a drive shaft driving assembly 34a which is similar in most respects to the housing assembly 34 except for the provision of an outer, generally tubular housing member 142 having longitudinal closely spaced apart radial projections or spline members 142a formed thereon also for the purpose of indicating that the drive shaft housing assembly 34A is not a manual actuating lever for a seat adjustment mechanism. Various numbers and depths of splines 142a may be provided as long as such form a surface interruption for the outer surface of the housing assembly 34a. In all other respects the housing assembly 34a is like the housing assembly 34.

FIG. 6 illustrates another embodiment of a drive shaft housing assembly in accordance with the invention and generally designated by the numeral 34b. Housing assembly 34b is similar in most respects to housing assemblies 34 and 34a except for the provision of an outer housing member 242 having a substantially polygonal cross-sectional shape, such as the hexagonal outer surface shown and indicated by reference numeral 242a. Again, the housing assembly 34b will provide a tactile sense for a person grasping the outer surface of the outer housing or cover member 242 that this member is not intended to be used as a manual actuating lever for a seat position adjustment mechanism.

FIG. 7 illustrates yet another embodiment of the invention wherein a housing assembly 34c is generally similar to the housing assemblies described hereinabove except for the non-circular outer surface of the outer housing member 342. Again, a somewhat unconventional shape of outer housing member 342 provided by the elliptical cross-sectional geometry of outer surface 342a of housing assembly 34c serves the purpose of identifying the structure as not being a manual actuating member for a manual seat adjustment mechanism.

Still further, the present invention contemplates that the outer housing or cover member of the housing assembly of the present invention may be eliminated while retaining the connector member 44 as the outer housing or cover of the drive shaft support structure. In FIG. 8, a drive shaft housing assembly 34d is illustrated and comprises the connector member 44 with the longitudinal splines 46 providing the surface interruption identification function previously described. Housing assembly 34d does include, as do the other housing assemblies, the tubular bearing member 50 for journaling a drive shaft 40.

Fabrication and operation of the drive shaft housing assemblies described herein are believed to be readily understandable to one of ordinary skill in the art based on the foregoing description. Although preferred embodiments of the invention have been described in detail herein, those skilled in the art will also recognize that various substitutions and modifications may be made without departing from the scope and spirit of the appended claims.

1. A drive shaft housing assembly for a vehicle power seat drive mechanism comprising:
an elongated outer housing member including a generally cylindrical bore;
an elongated connector member disposed in said bore and including opposed distal end parts extending beyond said outer housing member, said end parts including circumferentially spaced projections cooperable with respective housings for receiving said connector member therein;
a bearing bore formed in said connector member;
an elongated flexible tubular bearing member disposed in said bearing bore, said tubular bearing member including a central bore for receiving a drive shaft; and
said outer housing member including an exterior surface thereof for indicating to a person grasping said outer housing member a configuration other than a smooth handle of a manual actuating member.

2. The drive shaft housing assembly set forth in claim 1 including:
elongated circumferentially spaced grooves formed in said exterior surface of said outer housing member.

3. The drive shaft housing assembly set forth in claim 1 including:
circumferentially spaced radially extending projections on said exterior surface of said outer housing member.

4. The drive shaft housing assembly set forth in claim 1 wherein:
said outer housing member has a polygonal cross section shape.

5. The drive shaft housing assembly set forth in claim 1 wherein:
said outer housing member has a non-circular cross-section shape.

6. The drive shaft housing assembly set forth in claim 1 wherein:
at least one of said outer housing member and said connector are formed of rigid polyvinyl chloride.

7. The drive shaft housing assembly set forth in claim 1 wherein:
said tubular bearing member is formed of flexible polyvinyl chloride.

8. The drive shaft housing assembly set forth in claim 1 wherein:
said tubular bearing member is adapted to receive and support a rotatable drive shaft without requiring a lubricant to be interposed said drive shaft and said tubular bearing member.

9. A drive shaft housing assembly for a vehicle power seat drive mechanism comprising:
an elongated outer housing member formed of an extruded polymer and including a generally cylindrical bore therein and a noncircular exterior surface;
an elongated connector member formed of an extruded polymer and disposed in said bore and including opposed distal end parts extending beyond said outer housing member, said end parts including circumferentially spaced projections cooperable with respective housings for receiving said connector member therein;
a bearing bore formed in said connector member; and
an elongated flexible tubular bearing member formed of an extruded polymer and disposed in and freely rotatable in said bearing bore, said tubular bearing member including a central bore for receiving a drive shaft.

10. The drive shaft housing assembly set forth in claim 9 including:
circumferentially spaced radially extending projections on said exterior surface of said outer housing member.

11. The drive shaft housing assembly set forth in claim 9 wherein:
said outer housing member has a polygonal cross section shape.

12. The drive shaft housing assembly set forth in claim 9 wherein:
at least one of said outer housing member and said connector are formed of rigid polyvinyl chloride.

13. The drive shaft housing assembly set forth in claim 9 wherein:
said tubular bearing member is formed of flexible polyvinyl chloride having a hardness of about 70 to 100 Shore A durometer.

14. A drive shaft housing assembly for a vehicle power seat drive mechanism comprising:
an elongated housing member including a generally cylindrical bore therein and including opposed distal end parts including circumferentially spaced projections cooperable with respective housings for receiving said housing member therein;
an elongated flexible tubular bearing member disposed in and freely rotatable in said bore, said tubular bearing member including a central bore;
said tubular bearing member is adapted to receive and support a rotatable drive shaft without requiring a lubricant to be interposed said drive shaft and said tubular bearing member and interposed said housing member and said tubular bearing member; and
said housing member and said tubular bearing member each being formed of extruded polyvinyl chloride.

15. In a vehicle power seat, a seat frame, a drive motor mounted on said frame at a forward edge thereof, a drive mechanism for moving said seat in response to energizing said motor, and a drive shaft housing assembly for said drive mechanism extending transversely across said forward edge of said frame and including an elongated outer housing member, a connector member including opposed distal end parts extending beyond said outer housing member, said end parts including circumferentially spaced projections cooperable with respective housings for receiving said connector member therein, a bearing bore formed in said connector member, an elongated flexible tubular bearing member disposed in said bearing bore, said tubular bearing member including a central bore for receiving a drive shaft, and said outer housing member includes an exterior surface thereof for indicating to a person grasping said outer housing member a configuration other than a smooth handle of a manual actuating member.

16. The invention set forth in claim 15, including:
elongated circumferentially spaced grooves formed in said exterior surface of said outer housing member.

17. The invention set forth in claim 15 including:
circumferentially spaced radially extending projections on said exterior surface of said outer housing member.

18. The invention set forth in claim 15 wherein:
said outer housing member has a polygonal cross section shape.

19. The invention set forth in claim 15 wherein:
said outer housing member has a non-circular cross-section shape.

20. The invention set forth in claim 15 wherein:
said tubular bearing member is formed of flexible polyvinyl chloride.

21. The invention set forth in claim 15 wherein:
said tubular bearing member is adapted to receive and support a rotatable drive shaft without requiring a lubricant to be interposed said drive shaft and said tubular bearing member.
